(19) United States
(12) Patent Application Publication
(10) Pub. No.: US 2026/0213257 A1
(43) Pub. Date: Jul. 23, 2026

(54) METAL-SUBSTITUTED LITHIUM-DEFICIENT HALIDE-RICH SOLID ELECTROLYTES

(71) Applicants: Umicore, Brussels (BE); Centre National De La Recherche Scientifique, PARIS (FR); UNIVERSITE DE PICARDIE JULES VERNE, Amiens (FR)

(72) Inventors: Dhanush SHANBHAG, Paris (FR); Virginie VIALLET, Amiens (FR); Christian MASQUELIER, Amiens (FR)

(21) Appl. No.: 19/139,593

(22) PCT Filed: Dec. 18, 2023
(86) PCT No.: PCT/EP2023/086250

§ 371 Date: Jun. 16, 2025

(30) Foreign Application Priority Data
Dec. 19, 2022 (EP) 22290079.7

(51) Int. Cl. H01M 10/0562; H01M 10/052

(52) U.S. Cl. CPC H01M 10/0562; H01M 10/052; H01M 2300/008

(57) ABSTRACT

The present invention relates to a lithium-deficient halide-rich solid electrolyte substituted with zinc. The present inventors have surprisingly found that these zinc-substituted lithium-deficient halide-rich solid electrolytes display an increased ionic conductivity and a reduced H2S gas evolution upon contact with moisture.

### TECHNICAL FIELD AND BACKGROUND

This invention relates to a lithium-deficient halide-rich solid electrolyte substituted with zinc, a method for manufacturing said solid electrolyte and a battery comprising said solid electrolyte.

### BACKGROUND

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Among these, a lithium secondary battery has come into the spotlight as a high-performance battery due to a high energy density and a high reference electrode potential.

However, electrolytes conventionally used in lithium secondary batteries are liquid electrolytes such as organic solvents. Accordingly, safety problems such as leakage of electrolytes and risk of fire may continuously occur.

Recently, solid state batteries including solid electrolytes, rather than liquid electrolytes have been used to improve the safety feature of the lithium secondary battery and have attracted much attention. For example, solid electrolytes are typically safer than liquid electrolytes due to non-combustible or flame retardant properties.

Solid electrolytes may include oxide-based solid electrolytes, polymer-based electrolytes and sulfide-based electrolytes. Sulfide-based electrolytes have been generally used due to their higher lithium ionic conductivity range compared to oxide-based and polymer-based solid electrolytes, such as sulfide-based solid electrolytes having an argyrodite-type crystal structure.

US2021/0135278 A1 describes the synthesis of a lithium-deficient halide-rich solid electrolyte with the formula Li_{5.5}PS_{4.5}Cl_{0.25}Br_{1.25} and a sodium-substituted lithium-deficient halide-rich solid electrolyte with the formula Li_{5.45}Na_{0.05}PS_{4.5}Cl_{0.25}Br_{1.25}.

US2021/0047195 A1 describe the synthesis of a copper-substituted lithium-deficient solid electrolyte with the formula Li_{5.8}Cu_{0.1}PS₅Cl₁ and a zinc-substituted lithium-deficient solid electrolyte with the formula Li_{5.4}Zn_{0.1}PS_{4.6}Cl_{1.4}.

However, there remains a need to provide sulfide based electrolytes having a high ionic conductivity and a reduced H₂S gas evolution upon contact with moisture.

It is an object of the present invention to provide a lithium-deficient halide-rich solid electrolyte substituted with zinc.

It is a further object of the present invention to provide a method for manufacturing said solid electrolyte.

It is a further object of the present invention to provide a battery comprising said solid electrolyte.

### SUMMARY OF THE INVENTION

In a first aspect an object of the present invention is achieved by providing a solid electrolyte having a composition according to formula (I′)

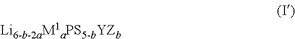

wherein 0<a<0.3, 0<b<0.8, M¹ is a divalent metal, Y is selected from the group consisting of F, Cl, Br and I, Z is selected from the group consisting of F, Cl, Br and I, and Y and Z are not the same halogen.

In a preferred embodiment the present invention is achieved by providing a solid electrolyte having a composition according to formula (I)

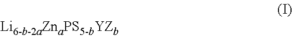

wherein 0.0<a<0.3, 0.0<b<0.8, Y is selected from the group consisting of F, Cl, Br and I, Z is selected from the group consisting F, Cl, Br and I, and Y and Z are not the same halogen.

The present inventors have surprisingly found that these metal-substituted lithium-deficient halide-rich solid electrolytes display an increased ionic conductivity, as demonstrated in the appended examples. Moreover, these solid electrolyte compositions according to the invention display a reduced H₂S gas evolution upon contact with moisture making them more attractive as solid electrolytes for commercial production and use in batteries.

Without wishing to be bound by any theory, these lithium sulfide-based solid electrolytes with an argyrodite structure, such as Li₆PS₅Cl, exhibit a high lithium cation mobility. The addition of a metal, such as zinc, which may occupy lithium cation sites in the argyrodite crystal structure and the fact that the lithium cations are replaced with zinc cations, suppresses H₂S formation, since ideally each zinc cation would coordinate with one sulfur anion. On the other side, the presence of halogen sites shows a significant disorder, which allows the coordination of the metal atoms, such as zinc, with more than one sulfur anion center. Furthermore, the fact that these solid electrolyte compositions according to the invention display a reduced H₂S gas evolution upon contact with moisture is a relevant safety aspect which makes them more attractive for commercial production and use in batteries.

In a further aspect the invention provides a method for manufacturing said solid electrolyte.

In a further aspect the invention provides the battery comprising the solid electrolyte according to the invention.

### BRIEF DESCRIPTION OF THE FIGURES

FIG. 1a: X-ray diffraction patterns, using Cu K_{α} radiation, of Li_{5.5-2x}ZnₓPS_{4.5}BrCl_{0.5} with nominal x=0, 0.05, 0.1, 0.15 and 0.2, recorded at 298 K in a Beryllium-capped tight cell.

FIG. 1b: Enlarged region of the XRD patterns of Li_{5.5-2x}ZnₓPS_{4.5}BrCl_{0.5} with nominal a=0, 0.05, 0.1, 0.15 and 0.2, between 2θ=43° to 48°.

FIG. 2a: X-ray diffraction patterns, using Cu K_{α} radiation, of Li_{5.5-2x}ZnₓPS_{4.4}BrCl_{0.6} with nominal x=0, 0.025 and 0.05, recorded at 298 K in a Beryllium-capped tight cell.

FIG. 2b: Enlarged region of the XRD patterns of Li_{5.5-2x}ZnₓPS_{4.4}BrCl_{0.6} with nominal x=0, 0.025 and 0.05, between 2θ=43° to 48°.

FIG. 3: Variation of lattice constant a with increasing x in Li_{5.5-2x}ZnₓPS_{4.5}BrCl_{0.5} with a=0, 0.025, 0.05, 0.075, 0.1, 0.15 and 0.2.

FIG. 4: Raman spectra of Li_{5.5-2x}ZnₓPS_{4.5}BrCl_{0.5} (x=0, 0.05, 0.1, 0.15 and 0.2).

FIG. 5a: H₂S generated per liter of air and mole of Li_{5.5-2x}ZnₓPS_{4.5}BrCl_{0.5} with nominal x=0, 0.05, 0.075, 0.1 and 0.15.

FIG. 5b: H₂S generated per liter of air and mole of Li_{5.5-2x}ZnₓPS_{4.4}BrCl_{0.6} with nominal a=0, 0.025 and 0.05.

### DETAILED DESCRIPTION

In the drawings and in the following detailed description, preferred embodiments are described in detail to enable practice of the invention. Although the invention is described with reference to these specific preferred embodiments, it will be understood that the invention is not limited to these preferred embodiments. To the contrary, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

The term “solid-state battery” as used herein refers to a cell or a battery that includes only solid or substantially solid-state components such as solid electrodes (e.g. anode and cathode) and solid electrolyte.

The term “argyrodite-type crystal structure” as used herein refers to a crystal structure having a crystal structure or system similar to naturally existing Ag₈GeS₆ and Li₇PS₆ (Argyrodite). The argyrodite-type crystal structure may be of orthorhombic symmetry or cubic symmetry and may be described in the F-43m space group. In some embodiments the argyrodite-type crystal structure may also be empirically determined, for example by X-ray diffraction by observing diffraction peaks around at 2θ=15.5±1°, 18±1°, 26±1°, 30.5±1° and 32±1° using CuKα-ray wavelength.

X-Ray diffraction (XRD) as referred to herein, refers to XRD experiments performed using Bruker D8 diffractometers equipped with either Cu (Kα₁-Kα₂) or Mo (Kα₁-Kα₂) radiation in a θ-θ configuration. Preferably, an air-tight sample holder capped with a Be window (mostly transparent to X-rays) is used. Preferably, the patterns were collected between 2θ=10°-50° with a step size of 0.02°.

Raman spectroscopy as referred to herein, refers to Raman experiments performed using a Raman DXR Microscope (Thermo Fischer Scientific) equipped with a green laser of excitation wavelength of 532 nm. Preferably, laser power of 0.1 mW was used to avoid sample damage due to excessive local heating. Preferably, spectra were collected by 1 second exposure time and 180 exposures.

Ionic conductivity as referred to herein, refers to the ionic conductivity determined at 25° C., unless described otherwise. It is preferably determined on cold pressed samples in a 10 mm die at 625 MPa with a BioLogic CESH cell and spectra were recorded using MTZ 35 frequency response analyzer by applying 50 mV AC perturbation in the frequency range from 30 MHz to 1 Hz. Preferably, the relative density of the pellet was 85 to 87% and the thickness was 1.4 mm approximately. Preferably, indium foils were pressed on the surface of pellets as ion-blocking electrodes. More preferably, spectra were collected between the temperature of range of −20 to 50° C. with 10° C. intervals in the ITS temperature controller.

Moisture stability as referred to herein, refers to measuring the amount of H₂S recorded in ppm every 20 seconds for 20 minutes with a H₂S sensor (model-INS-H₂S-03 (0-400 ppm, 20-90% RH). Preferably, approximately 30 mg of powder was pelletized in a 10 mm die and the pellet was placed on a rectangular polymer container in a desiccator, and the lid of the desiccator was closed. The temperature during the measurement was between 19° C. to 22° C., the relative humidity between 42-45%. The number of moles of H₂S generated per liter of ambient air and gram of sample were calculated using the following equation:

$$\frac{1 {ppm}_{H 2 S} * {MM}_{sample}}{{m}_{sample} * 24.79} = \frac{{mol}_{H2S} * {10}^{- 5}}{1 {Liter}_{air} * 1 {mol}_{sample}}$$

In the context of the present invention a liquid shall be considered to be an organic or aqueous compound which is liquid in standard conditions for temperature and pressure as defined by the IUPAC. Hereby the boiling point and the melting point shall be considered to be the boiling point and the melting point at standard atmospheric pressure, i.e. at 101325 Pa. As appreciated by the skilled person the presence of the organic liquid can be determined via thermogravimetric analysis (TGA) or nuclear magnetic resonance (NMR) spectroscopy and the presence of the aqueous liquid can be determined via Karl Fisher titration.

The term “solid electrolyte mixture” as used herein refers to an electrolyte mixture being essentially free of any liquid. The term “essentially free of liquid” means that the solid electrolyte mixture comprises less than 10 wt. % of a liquid by total weight of the solid electrolyte mixture, preferably less than 7.5 wt. %, more preferably less than 5 wt. %, even more preferably less than 2.5 wt. %, most preferably less than 1 wt. % by total weight of the solid electrolyte mixture. In a more preferred embodiment the solid electrolyte mixture comprises less than 1000 ppm of a liquid by total weight of the solid electrolyte mixture, preferably less than 500 ppm, more preferably less than 100 ppm, even more preferably less than 50 ppm, most preferably less than 10 ppm by total weight of the solid electrolyte mixture.

The term “solid electrolyte” as used herein refers to an electrolyte being essentially free of any liquid. The term “essentially free of liquid” means that the solid electrolyte comprises less than 10 wt. % of a liquid by total weight of the solid electrolyte, preferably less than 7.5 wt. %, more preferably less than 5 wt. %, even more preferably less than 2.5 wt. %, most preferably less than 1 wt. % by total weight of the solid electrolyte. In a more preferred embodiment the solid electrolyte comprises less than 1000 ppm of a liquid by total weight of the solid electrolyte, preferably less than 500 ppm, more preferably less than 100 ppm, even more preferably less than 50 ppm, most preferably less than 10 ppm by total weight of the solid electrolyte.

### Solid Electrolyte

In a first aspect the invention provides a solid electrolyte having a composition according to formula (I′)

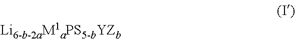

wherein 0<a<0.3,
wherein 0<b<0.8,
wherein M¹ is a divalent metal
wherein Y is selected from the group consisting of F, Cl, Br and I,
wherein Z is selected from the group consisting of F, Cl, Br and I, and
wherein Y and Z are not the same halogen.

In preferred embodiments the solid electrolyte is according to the invention, wherein M¹ is selected from the group consisting of Zn, Cd, Be, Sr, Ba and combinations thereof, preferably the group consisting of Zn, Cd, Be, Sr and Ba, preferably M¹ is Zn.

In preferred embodiments the invention provides a solid electrolyte having a composition according to formula (I)

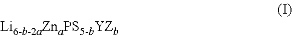

wherein 0.0<a<0.3, 0.0<b<0.8;
wherein Y is selected from the group consisting of F, Cl, Br and I;
wherein Z is selected from the group consisting F, Cl, Br and I; and
wherein Y and Z are not the same halogen.

In preferred embodiments the solid electrolyte is according to the invention, wherein 0.01≤a≤0.29, preferably 0.02≤a≤0.25, more preferably 0.025≤a≤0.2. In certain preferred embodiments the solid electrolyte is according to the invention, wherein 0.0<a≤0.20, preferably 0.02≤a≤0.20, more preferably 0.025≤a≤0.20. In certain preferred embodiments the solid electrolyte is according to the invention, wherein 0.0<a≤0.20, preferably 0.02≤a≤0.18, more preferably 0.025≤a≤0.15.

In preferred embodiments the solid electrolyte is according to the invention, wherein 0.1≤b<0.8, preferably 0.3≤b≤0.7, more preferably 0.4≤b≤0.6. In certain preferred embodiments the solid electrolyte is according to the invention, wherein 0.5≤b≤0.6, preferably b=0.5 or 0.6, more preferably b=0.5.

In preferred embodiments the solid electrolyte is according to the invention, wherein Y is Cl, Br or I, more preferably Y is Br or I, most preferably Y is Br.

In certain preferred embodiments the solid electrolyte is according to the invention, wherein Z is Cl, Br or I, more preferably Z is Cl or I, most preferably Z is Cl.

In preferred embodiments the solid electrolyte is according to the invention, wherein the molar ratios of U:Zn:P:S:Y:Z are between (5-6):(0-0.3):(0.9-1.1):(4.1-5.1):(0.1-1.0):(0.1-1.0), preferably (5.1-5.9):(0.01-0.3):(0.91-1.09):(4.2-5.0):(0.91-1.09):(0.2-0.8), more preferably (5.1-5.5):(0.025-0.25):(0.99-1.01):(4.3-4.8):(0.99-1.01):(0.40-0.60), most preferably (5.10-5.45):(0.025-0.20):1.0:(4.4-4.5):1.0:(0.5-0.6).

In preferred embodiments the solid electrolyte is according to the invention having a purity of at least 90%, preferably at least 95%, more preferably at least 99%, as determined by XRD.

In preferred embodiments the solid electrolyte is according to the invention having a F-43m space group, preferably with a lattice parameter a (A) between 9.900 and 9.925, as determined by least square refinements of XRD profile and/or Rietveld analysis at 298 K.

In preferred embodiments the solid electrolyte is according to the invention having a conductivity between 1 and 12 mS/cm, preferably between 3 and 10 mS/cm, more preferably between 4 and 9 mS/cm.

In preferred embodiments the solid electrolyte is according to the invention displaying a peak between 420 cm⁻¹ and 430 cm⁻¹, preferably between 421 cm⁻¹ and 429 cm⁻¹, most preferably between 422 cm⁻¹ and 428 cm⁻¹, as determined by Raman spectroscopy.

In preferred embodiments the solid electrolyte is according to the invention having a good moisture stability, in particular the solid electrolyte generated or released less than 2.8 mmol·L⁻¹·g⁻¹ H₂S after 15 minutes, preferably less than 2.6 mmol·L⁻¹·g⁻¹ H₂S after 15 minutes, more preferably less than 2.0 mmol·L⁻¹·g⁻¹ H₂S after 15 minutes, most preferably less than 1.5 mmol·L⁻¹·g⁻¹ H₂S after 15 minutes, as determined via moisture stability.

In certain preferred embodiments the solid electrolyte is according to the invention having a good moisture stability, in particular the solid electrolyte generated or released less than 2.8 mmol·L⁻¹·mol⁻¹ H₂S after 15 minutes, preferably less than 2.6 mmol·L⁻¹·mol⁻¹ H₂S after 15 minutes, more preferably less than 2.0 mmol·L⁻¹·mol⁻¹ H₂S after 15 minutes, most preferably less than 1.5 mmol·L⁻¹·mol⁻¹ H₂S after 15 minutes, as determined via moisture stability.

In preferred embodiments the solid electrolyte is according to the invention having an argyrodite-type crystal structure.

In certain preferred embodiments the solid electrolyte is according to the invention, wherein
Y is Br;
Z is Cl;
0.01≤a≤0.29, preferably 0.02≤a≤0.25, more preferably 0.025≤a≤0.2; and
0.1≤b<0.8, preferably 0.3≤b≤0.7, more preferably 0.4≤b≤0.6.

In certain preferred embodiments the solid electrolyte is according to the invention, wherein
Y is Br;
Z is Cl;
0<a≤0.2, preferably 0.02≤a≤0.2, more preferably 0.025≤a≤0.15; and
0.5≤b≤0.6, preferably b=0.5 or 0.6.

In certain preferred embodiments the solid electrolyte is according to the invention, having a composition according to formula (II)

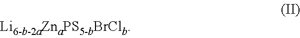

In certain preferred embodiment the solid electrolyte of the invention is according to formula (II), wherein 0.01≤a≤0.29, preferably 0.02≤a≤0.25, more preferably 0.025≤a≤0.2 and 0.1≤b<0.8, preferably 0.3≤b≤0.7, more preferably 0.4≤b≤0.6. In certain preferred embodiments the solid electrolyte is according to the invention, wherein 0.0<a≤0.20, preferably 0.02≤a≤0.18, more preferably 0.025≤a≤0.15.

In more preferred embodiments the solid electrolyte is according to the invention, wherein the solid electrolyte is according to formula (II)a-g, preferably according to formula (II)a-d and (II)f-g, more preferably according to formula (II)a-d:

| | |
|---|---|
| Li_{5.35}Zn_{0.025}PS_{4.4}Br_{1.0}Cl_{0.6} | (II)a |
| Li_{5.30}Zn_{0.05}PS_{4.4}Br_{1.0}Cl_{0.6} | (II)b |
| Li_{5.45}Zn_{0.025}PS_{4.5}Br_{1.0}Cl_{0.5} | (II)c |
| Li_{5.40}Zn_{0.05}PS_{4.5}Br_{1.0}Cl_{0.5} | (II)d |
| Li_{5.35}Zn_{0.075}PS_{4.5}Br_{1.0}Cl_{0.5} | (II)e |
| Li_{5.30}Zn_{0.10}PS_{4.5}Br_{1.0}Cl_{0.5} | (II)f |
| Li_{5.20}Zn_{0.15}PS_{4.5}Br_{1.0}Cl_{0.5} | (II)g |

In preferred embodiments the solid electrolyte of the invention is according to formula (II) having a purity of at least 90%, preferably at least 95%, more preferably at least 99%, as determined by XRD.

In certain preferred embodiments the solid electrolyte of the invention is according to formula (II) having a F-43m space group, preferably with a lattice parameter a (Å) between 9.900 and 9.925, as determined by least square refinements of XRD profile and/or Rietveld analysis.

In preferred embodiments the solid electrolyte is according to formula (II), preferably according to formula (II)a-h, having a conductivity between 1 and 12 mS/cm, preferably between 3 and 10 mS/cm, more preferably between 4 and 9 mS/cm.

In preferred embodiments the solid electrolyte is according to formula (II), preferably according to formula (II)a-h, having a peak between 420 cm⁻¹ and 430 cm⁻¹, preferably between 421 cm⁻¹ and 429 cm⁻¹, most preferably between 422 cm⁻¹ and 428 cm⁻¹, as determined by Raman spectroscopy.

In preferred embodiments the solid electrolyte is according to formula (II), preferably according to formula (II)a-h, having a good moisture stability, in particular the solid electrolyte generated or released less than 2.8 mmol·L⁻¹·g⁻¹ H₂S after 15 minutes, preferably less than 2.6 mmol·L⁻¹·g⁻¹ H₂S after 15 minutes, more preferably less than 2.0 mmol·L⁻¹·g⁻¹ H₂S after 15 minutes, most preferably less than 1.5 mmol·L⁻¹·g⁻¹ H₂S after 15 minutes, as determined via moisture stability.

In certain preferred embodiments the solid electrolyte is according to formula (II), preferably according to formula (II)a-h, having a good moisture stability, in particular the solid electrolyte generated or released less than 2.8 mmol·L⁻¹·mol⁻¹ H₂S after 15 minutes, preferably less than 2.6 mmol·L⁻¹·mol⁻¹ H₂S after 15 minutes, more preferably less than 2.0 mmol·L⁻¹·mol⁻¹ H₂S after 15 minutes, most preferably less than 1.5 mmol·L⁻¹·mol⁻¹ H₂S after 15 minutes, as determined via moisture stability.

In preferred embodiments the solid electrolyte is according to formula (II), preferably according to formula (II)a-h, having an argyrodite-type crystal structure.

In certain preferred embodiments the solid electrolyte of the invention is according to formula (II)a, preferably having a conductivity between 8.0 and 9.0 mS/cm, preferably between 8.25 and 8.75 mS/cm, most preferably 8.5 mS/cm.

In certain preferred embodiments the solid electrolyte of the invention is according to formula (II)b, preferably having a conductivity between 6.5 and 8.0 mS/cm, preferably between 7.0 and 7.5 mS/cm, most preferably 7.2 mS/cm.

In certain preferred embodiments the solid electrolyte of the invention is according to formula (II)c, preferably having a conductivity between 6.0 and 7.0 mS/cm, preferably between 6.25 and 6.75 mS/cm, most preferably 6.2 mS/cm.

In certain preferred embodiments the solid electrolyte of the invention is according to formula (II)d, preferably having a conductivity between 4.5 and 6.0 mS/cm, preferably between 5.0 and 5.5 mS/cm, most preferably 5.1 mS/cm.

In certain preferred embodiments the solid electrolyte of the invention is according to formula (II)e, preferably having a conductivity between 4.5 and 6.0 mS/cm, preferably between 5.0 and 5.5 mS/cm, most preferably 5.3 mS/cm.

In certain preferred embodiments the solid electrolyte of the invention is according to formula (II)f, preferably having a conductivity between 5.0 and 6.5 mS/cm, preferably between 5.5 and 6.0 mS/cm, most preferably 5.9 mS/cm.

In certain preferred embodiments the solid electrolyte of the invention is according to formula (II)g having a conductivity between 3.5 and 4.5 mS/cm, preferably between 3.75 and 4.25 mS/cm, most preferably 4.0 mS/cm.

### Method for Manufacturing

In a second aspect the invention provides a method for manufacturing a solid electrolyte comprising the following steps:
a) providing a set of precursors comprising Li, P, S, M², Y and Z;
b) mixing of the set of precursors to obtain a solid electrolyte mixture; and
c) heat-treating of the solid electrolyte mixture to obtain a solid electrolyte;
wherein M² is a divalent metal, preferably wherein M² is selected from the group consisting of Zn, Cd, Be, Sr, Ba and combinations thereof, more preferably the group consisting of Zn, Cd, Be, Sr and Ba, most preferably M² is Zn.
wherein Y is selected from the group consisting of F, Cl, Br and I, preferably Y is F, Br or I, more preferably Y is Br or I, most preferably Y is Br;
Z is selected from the group consisting of F, Cl, Br and I, preferably Z is F, Cl or I, more preferably Z is F or Cl, most preferably Z is Cl; and
wherein Y and Z are not the same halogen.

In highly preferred embodiments the method is according to the invention, wherein the set of precursors comprises L₂, P₂S₅, ZnS, LiY and LiZ.

In highly preferred embodiments the method is according to the invention, wherein the solid electrolyte is the solid electrolyte according to the first aspect of the invention, preferably the solid electrolyte according to formula (I) and/or according to formula (II), preferably according to formula (II)a-g.

As appreciated by the skilled person all embodiments related to the solid electrolyte according to first aspect of the invention apply mutatis mutandis to the method for manufacturing the solid electrolyte according to the invention. For example, the various embodiments relating to formula (I), formula (II), purity level, conductivity level and moisture level as explained herein in the context of the solid electrolyte are equally applicable to the method for manufacturing the solid electrolyte according to the invention.

In preferred embodiments the method is according to the invention, wherein the mixing of the solid electrolyte precursor of step b) may comprise mixing, grinding, stirring, ball-milling, or a combination thereof.

In preferred embodiments the method is according to the invention, wherein the mixing of the set of precursors of step b) with a mixing speed of at least 100 rpm, preferably a mixing speed of at least 300 rpm, most preferably a mixing speed of at least 400 rpm. In preferred embodiments the method is according to the invention, wherein the mixing of the set of precursors of step b) with a mixing speed of at most 1000 rpm, preferably a mixing speed of at most 900 rpm, most preferably a mixing speed of at most 800 rpm. In preferred embodiments the method is according to the invention, wherein the mixing of the set of precursors of step b) with a mixing speed of 100-1000 rpm, preferably a mixing speed of 300-900 rpm, most preferably a mixing speed of 400-800 rpm.

In preferred embodiments the method is according to the invention, wherein the mixing of the set of precursors of step b) is at least 1 hour, preferably at least 5 hours, most preferably at least 10 hours. In preferred embodiments the method is according to the invention, wherein the mixing of the set of precursors of step b) is at most 70 hours, preferably at most 50 hours, most preferably at most 30 hours. In preferred embodiments the method is according to the invention, wherein the mixing of the set of precursors of step b) is between 1 hour to 70 hours, preferably between 5 hours to 50 hours, most preferably between 10 hours to 30 hours.

In preferred embodiments the method is according the invention, wherein the mixing of the solid electrolyte precursor mixture of step b) occurs at a temperature of at least 5° C., preferably at least 10° C., more preferably at least 15° C. A preferred embodiment is the method according to the invention, wherein the mixing of the solid electrolyte precursor mixture of step b) occurs at a temperature of less than 50° C., preferably less than 40° C., more preferably less than 30° C. A preferred embodiment is the method according to the invention, wherein the mixing of the solid electrolyte precursor mixture of step b) occurs at a temperature between 5 and 50° C., preferably a temperature between 1° and 40° C., more preferably a temperature between 15 and 30° C.

In certain preferred embodiments the method is according to the invention, wherein the mixing of the solid electrolyte precursor of step b)
with a mixing time between 1 hour and 70 hours, preferably between 5 hours and 50 hours, most preferably between 10 hours and 30 hours; and
with a mixing speed of 100-1000 rpm, preferably a mixing speed of 300-900 rpm, most preferably a mixing speed of 400-800 rpm.

In preferred embodiments the method is according to the invention, wherein the heat-treating of the solid electrolyte mixture of step c) occurs at a pressure of at most 100 Pa, preferably at most 10 Pa, more preferably at most 1 Pa. In preferred embodiments the method is according to the invention, wherein the heat-treating of the solid electrolyte mixture of step c) occurs at a pressure of at least 10⁻² Pa, preferably at least 10⁻³ Pa, more preferably at least 10⁻⁴ Pa. In preferred embodiments the method is according to the invention, wherein the heat-treating of the solid electrolyte mixture of step c) occurs at a pressure between 10⁻² and 100 Pa, preferably between 10 and 10⁻³ Pa, more preferably between 1 and 10⁻⁴ Pa. In certain highly preferred embodiments the method is according to the invention, wherein before the heat-treating in step c) the solid electrolyte mixture from step b) was pressed, preferably uniaxially pressed, into a pellet, preferably a 10 mm pellet, affording a pressed solid electrolyte mixture. Preferably the pressed solid electrolyte mixture was placed in pre-dried quartz tubes, preferably then flame-sealed under vacuum, preferably at a pressure between 10⁻ and 100 Pa, preferably between 10 and 10⁻³ Pa, more preferably between 1 and 10⁻⁴ Pa. The pressed and flame-sealed solid electrolyte mixture is then subjected to the heat-treating step of step c).

In preferred embodiments the method is according to the invention, wherein the heat-treating of the solid electrolyte mixture of step c) occurs at a temperature of at least 100° C., preferably at least 200° C., more preferably at least 300° C., even more preferably at least 400° C., most preferably at least 450° C. In preferred embodiments the method is according to the invention, wherein the heat-treating of the solid electrolyte mixture of step c) occurs at a temperature of less than 1000° C., preferably less than 900° C., more preferably less than 750° C., even more preferably less than 600° C., most preferably less than 500° C. In preferred embodiments the method is according to the invention, wherein the heat-treating of the solid electrolyte mixture of step c) occurs at a temperature between 10° and 1000° C., preferably between 30° and 750° C., most preferably between 45° and 550° C.

In preferred embodiment the method is according to the invention, wherein the heat-treating of the solid electrolyte mixture of step c) is at least 1 min, preferably at least 0.5 hour, more preferably at least 1 hour, even more preferably at least 2.5 hours, most preferably at least 5 hours. In preferred embodiments the method is according to the invention, wherein the heat-treating of the solid electrolyte mixture of step c) is less than 48 hours, preferably less than 24 hours, more preferably less than 18 hours, even more preferably less than 12 hours, even more preferably less than 10 hours. In preferred embodiments the method is according to the invention, wherein the heat-treating of the solid electrolyte mixture of step c) is between 0.5 hour and 24 hours, preferably between 1 hours and 12 hours, more preferably between 2.5 hours and 10 hours.

In certain preferred embodiment the method is according to the invention, wherein the heat-treating of the solid electrolyte mixture of step c)
occurs at a temperature between 10° and 1000° C., preferably between 30° and 750° C., most preferably between 45° and 550° C.; and
is between 0.5 hour and 24 hours, preferably between 1 hours and 12 hours, most preferably between 2.5 hours and 10 hours.

In certain preferred embodiments the method is according to the invention, wherein the heat-treating of the solid electrolyte mixture of step c)
occurs at a temperature between 10° and 1000° C., preferably between 30° and 750° C., most preferably between 45° and 550° C.; and
occurs at a pressure between 10⁻² and 100 Pa, preferably between 10 and 10⁻³ Pa, more preferably between 1 and 104 Pa.

In certain preferred embodiment the method is according to the invention, wherein the heat-treating of the solid electrolyte mixture of step c)
occurs at a temperature between 10° and 1000° C., preferably between 30° and 750° C., most preferably between 45° and 550° C.;
occurs at a pressure between 10⁻² and 100 Pa, preferably between 10 and 10⁻³ Pa, more preferably between 1 and 104 Pa; and
is between 0.5 hour and 24 hours, preferably between 1 hours and 12 hours, most preferably between 2.5 hours and 10 hours.

### Product-by-Process

In a third aspect the invention concerns the solid electrolyte obtainable by the method according to the second aspect of the invention.

As appreciated by the skilled person all embodiments directed to the solid electrolyte according to the first aspect of the invention and/or the method according to the second aspect of the invention apply mutatis mutandis to solid electrolyte obtainable by the method according to the invention. For example, the various embodiments relating to formula (I), formula (II), purity level, conductivity level and moisture stability level as explained herein in the context of the solid electrolyte are equally applicable to the solid electrolyte obtainable by the method for manufacturing the solid electrolyte.

### Battery

A fourth aspect of the invention concerns a battery comprising a negative electrode, a positive electrode and a solid electrolyte layer, wherein at least one of the positive electrode, the negative electrode and the solid electrolyte layer comprises the solid electrolyte according to the invention. The present solid electrolyte of the invention can be used as a solid electrolyte layer of a solid lithium ion battery or a solid lithium primary cell, or as a solid electrolyte that is mixed with an electrode mixture for a positive electrode or a negative electrode.

In a preferred embodiment the battery is a solid-state battery, preferably a lithium solid-state battery.

### Use

A fifth aspect of the invention concerns a use of the solid electrolyte according to the invention in a battery, preferably a solid-state-battery, most preferably a lithium solid-state-battery.

A sixth aspect of the present invention concerns a use of the battery according to the invention in either one of a portable computer, a tablet, a mobile phone, an energy storage system, an electric vehicle or in a hybrid electric vehicle, preferably in a vehicle or in a hybrid electric vehicle.

The invention is further illustrated in the following examples:

### EXAMPLES

### Description of Testing Methods

### Synthesis Protocol

All the synthesis work and sample treatment were carried out in Ar filled glovebox with O₂ and H₂O levels <0.1 ppm. Stoichiometric ratios of reagents, Li₂S (Sigma Aldrich, 99.98%), ZnS (Sigma Aldrich, 99.9%), P₂S₅ (Sigma Aldrich, 99%), LiY (Y=Br; Alfa Aesar, 99%) and LiZ (Z=Cl; Alfa Aesar, 99%) were mixed to obtain a 2 g batch of precursor. For CEX1-2 no ZnS is added, for CEX3 Na₂S (Sigma Aldrich) is added. The precursors were transferred into a Fritsch Pulverisette 7 premium line 80 mL zirconia ball-milling jar along with 20 zirconia balls of 10 mm diameter (ball: powder ratio was 30:1). The precursors were initially milled at 150 rpm for 30 minutes to homogenize the mixture followed by ball milling at 600 rpm for a total duration of 20 hours. Each cycle constituted in 15-minute milling and 10-minute rest and reversing the direction of milling for every cycle. After every 8 hours of milling, the ball-milling jars were opened in the glovebox to scrape the material adhered to the cap and inside the surface of the jar. The ball-milled powder was uniaxially pressed into a 10 mm pellet and placed in pre-dried quartz tubes which were then flame-sealed under vacuum (10⁻²-10⁻⁴ mbar) and placed in a furnace (Nabertherm) for annealing. The temperature of the furnace was slowly increased to 525° C. at a ramp rate of 1.5° C./min, held for 5 hours, and naturally cooled to room temperature. The reacted pellets were then pulverized using a pestle and mortar and stored in the glovebox for further analysis.

### X-Ray Diffraction

The powder X-ray diffraction patterns were collected using Bruker D8 diffractometers equipped with either Cu (Kα₁-Kα₂) or Mo (Kα₁-Kα₂) radiation in a θ-θ configuration. An air-tight sample holder with a Be window was used for the measurements. The patterns were collected between 2θ=10°-50° with a step size of 0.02°. The Fullprof suite was used to perform profile matching using the Le Bail method to determine the lattice parameters of the samples.

### Raman Spectroscopy

The samples are air-sensitive so a small quantity of powder was flame-sealed in a disposable glass micropipette. The spectra were collected using a Raman DXR Microscope (Thermo Fischer Scientific) equipped with a green laser of excitation wavelength of 532 nm. Laser power of 0.1 mW was used to avoid sample damage due to excessive local heating. Spectra were collected by 1 second exposure time and 180 exposures.

### Ionic Conductivity

About 200 mg of sample was uniaxially cold-pressed in a 10 mm die at 625 MPa. The relative density of the pellet was 85 to 8⁷% and the thickness was 1.4 mm approximately. Indium foils were pressed on the surface of pellets as ion-blocking electrodes. AC impedance spectroscopy was performed on these pellets by mounting them in BioLogic CESH cell and spectra were recorded using MTZ 35 frequency response analyzer by applying 50 mV AC perturbation in the frequency range from 30 MHz to 1 Hz. Spectra were collected between the temperature of range of −20 to 50° C. with 10° C. intervals in the ITS temperature controller. The AC impedance data were analyzed using Zview or RelaxIS software.

### Moisture Stability

All the measurements were carried out on the same day to avoid the changes in humidity in ambient air (19-22° C., 42-45% relative humidity). H₂S sensing experiments were performed in the following set up approximately 45 mg of powder was pelletized in 10 mm die and these pellets were used for the measurement. To start the measurement, the pellet was placed on a rectangular polymer container in the desiccator, and the lid of the desiccator was closed. H₂S value in ppm was recorded every 20 seconds for 15 minutes with a H₂S sensor (model-INS-H2S-03 (0-400 ppm, 20-90% RH)). The number of moles of H₂S generated per litre of ambient air and gram of sample were calculated using the following equations:

$$1 {ppm}_{H 2 S} = \frac{1 {Liter}_{H 2 S} * 1 {0}^{- 6}}{1 {Liter}_{a i r}}$$

The right side is multiplied by 10 as the desiccator has a volume of 10 L. Assuming that H₂S behaves like an ideal gas, we divided both sides by Vₘ, which is the molar volume of ideal gas at 1 bar and RT (24.79 L·mol⁻¹):

$$\frac{1 {ppm}_{H 2 S}}{24.79} = \frac{1 {mol}_{H 2 S} * 1 {0}^{- 5}}{1 {Liter}_{a i r}} as \frac{1 {Liter}_{H 2 S}}{{V}_{m}} = 1 {mol}_{H 2 S}$$

Normalizing both sides with respect to the weight of the sample (mₛₐₘₚₗₑ) leads to:

$$\frac{1 {ppm}_{H 2 S}}{{m}_{sample} * 24.79} = \frac{1 {mol}_{H 2 S} * 1 {0}^{- 5}}{1 {Liter}_{a i r} * 1 {g}_{sample}}$$

Using this formula, the number of moles of H₂S generated per 1 L of air and 1 g of sample was plotted as a function of time, which is useful for designing the production and the assembly stages in larger scales. Further, the reactivities of S atoms in each material in the presence of moisture is compared. To this end, the number moles of H₂S generated per 1 L of air and 1 mol of sample after 15 minutes of exposure is calculated using the equation below:

$$\frac{1 {ppm}_{H 2 S} * M {M}_{sample}}{{m}_{sample} * 24.79} = \frac{{mol}_{H 2 S} * 1 {0}^{- 5}}{1 {Liter}_{a i r} * 1 {mol}_{sample}}$$

in which MMₛₐₘₚₗₑ is the molar mass of the sample (assuming that 100% purity) in g·mol⁻¹.

### EXAMPLES

Table 1 displays the overall formula of the examples synthesized via the general synthesis protocol described above with their corresponding ionic conductivity.

TABLE 1
Overall formula, ionic conductivities and lattice
constant of CEX1-3 and EX1-8.

| | | Ionic | |
|---|---|---|---|
| | | Conductivity | Lattice |
| | | at 25° C. | constant, |
| Examples | Formula | (mS/cm) | a (Å) |
| CEX1 | Li_{5.4}PS_{4.4}BrCl_{0.6} | 9.8 | 9.9190 |
| CEX2 | Li_{5.5}PS_{4.5}BrCl_{0.5} | 8.8 | 9.9287 |
| CEX3 | Li_{5.45}Na_{0.05}PS_{4.5}Br_{1.0}Cl_{0.5} | 0.9 | — |
| EX1 | Li_{5.35}Zn_{0.025}PS_{4.4}Br_{1.0}Cl_{0.6} | 8.5 | 9.914 |
| EX2 | Li_{5.30}Zn_{0.05}PS_{4.4}Br_{1.0}Cl_{0.6} | 7.2 | 9.908 |
| EX3 | Li_{5.45}Zn_{0.025}PS_{4.5}Br_{1.0}Cl_{0.5} | 6.2 | 9.9236 |
| EX4 | Li_{5.40}Zn_{0.05}PS_{4.5}Br_{1.0}Cl_{0.5} | 5.1 | 9.9180 |
| EX5 | Li_{5.35}Zn_{0.075}PS_{4.5}Br_{1.0}Cl_{0.5} | 5.3 | 9.9140 |
| EX6 | Li_{5.30}Zn_{0.10}PS_{4.5}Br_{1.0}Cl_{0.5} | 5.9 | 9.9092 |
| EX7 | Li_{5.20}Zn_{0.15}PS_{4.5}Br_{1.0}Cl_{0.5} | 4.0 | 9.9054 |

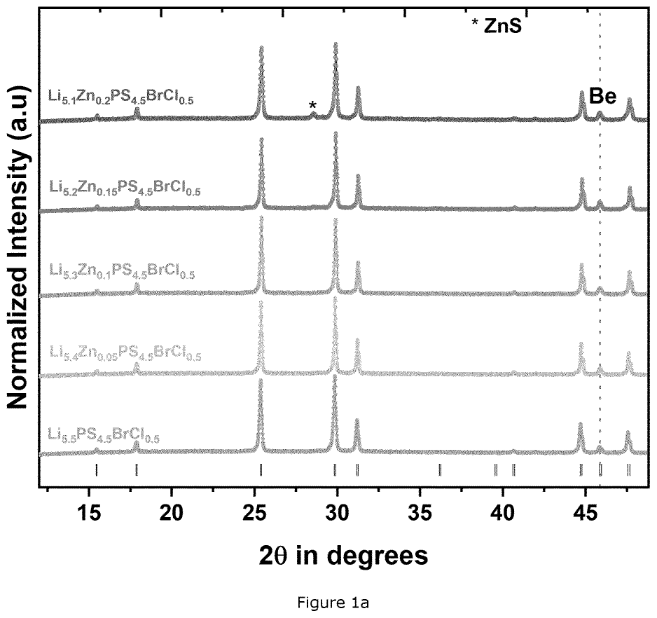

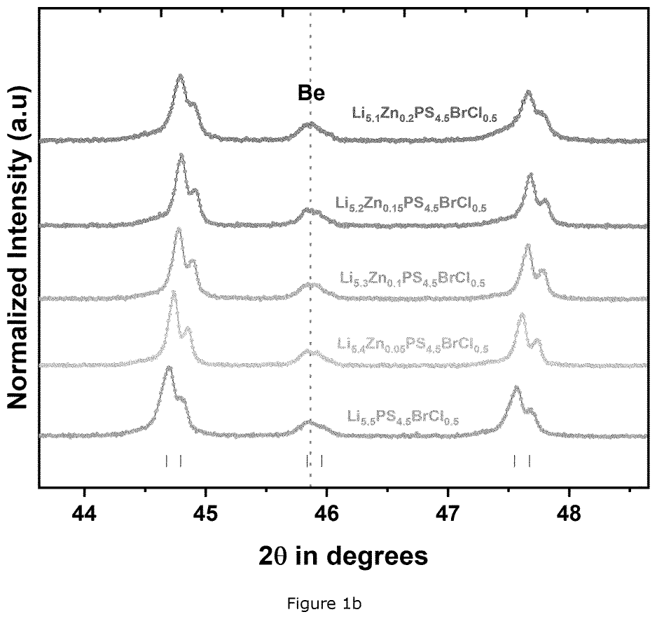

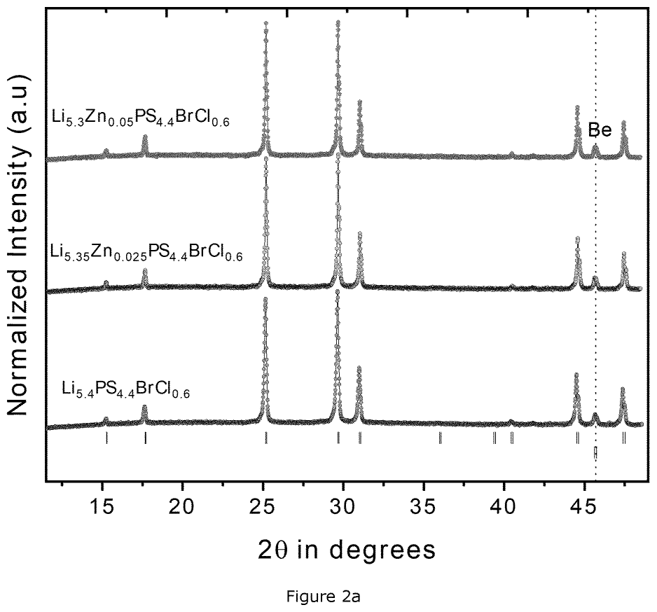

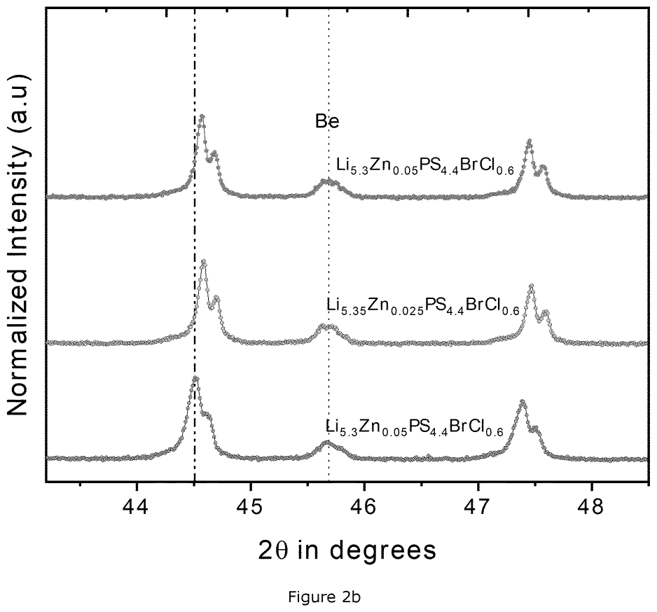

Profile matching of powder X-ray diffraction data suggest that the argyrodite structure is preserved for EX1-2 and EX4, 6-7 (space group: F4-3m; see FIGS. 1a,b and FIGS. 2a,b). No peaks corresponding to the precursors or other impurity phases are observed except for the peak at 2θ=45.6° from Be-containing sample holder. Comparison of the powder diffraction patterns, such as CEX1 with EX1-2 and CEX2 with EX4 and EX6-7, confirms the successful synthesis of the solid electrolyte according to the invention (FIGS. 1a, 1b, 2a and 2b).

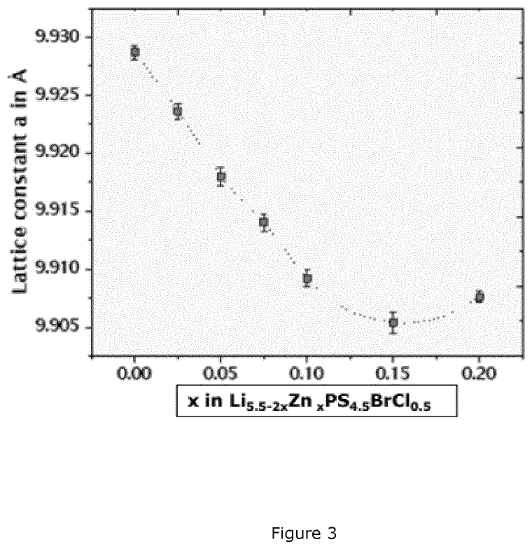

The calculated lattice parameter values, which are obtained by performing profile matching using the Le Bail method are gathered in FIG. 3 and Table 1, indicate the linear variation in lattice constant values that follows Vegard's law, and confirm the successful preparation of EX1-7. When increasing the Zn-content, it is shown that the cubic lattice parameter a gradually decreases from 9.9287 Å for CEX2 to 9.9054 for EX7 (FIG. 3) and 9.919 Å for CEX1 to 9.908 Å for EX2 (Table 1).

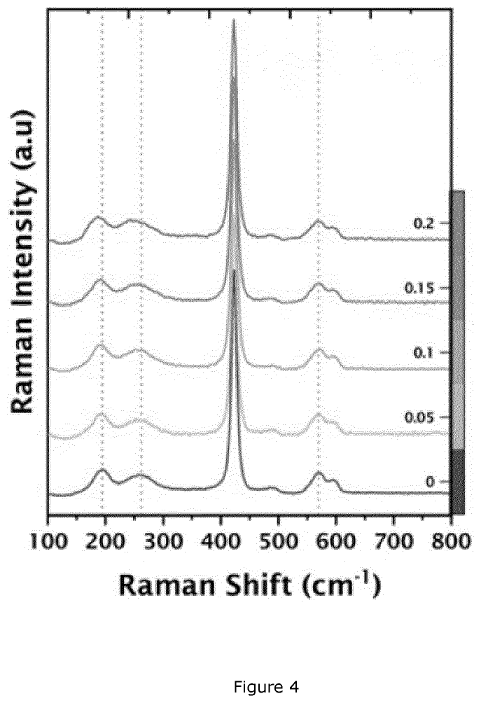

Raman spectroscopy was carried out to further confirm the effect of Zn substitution on the structure of EX4, EX6-7 and CEX2. As shown in FIG. 3, Raman spectra of all the samples show a sharp peak at 421 cm⁻¹ (v_{sym}) accompanied by other prominent peaks at ~200, 268, 568, and 593 cm⁻¹ all corresponding to different normal modes of PS₄ tetrahedron. With increasing Zn content, the position of the symmetric stretching mode (v_{sym}) at 421 cm⁻¹ is gradually shifting towards a higher wavenumber (FIG. 4).

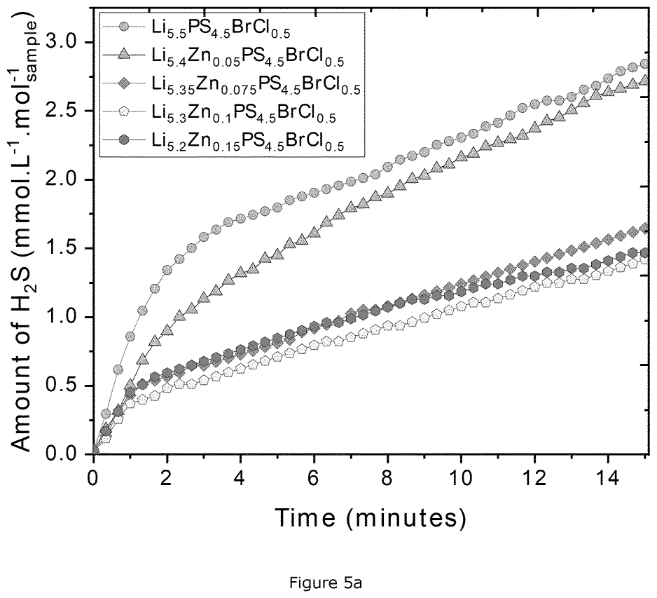

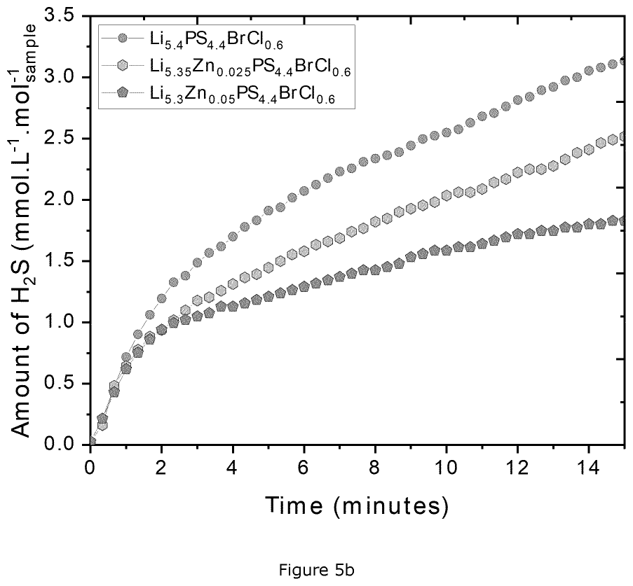

H₂S evolution measurements of all the samples were measured on the same day to maintain the relative humidity constant (see Table 2). FIG. 5a shows the quantity of H₂S evolved over 15 minutes for EX4-7 versus CEX2, and it is evident that H₂S evolution is considerably lesser for EX5-7, when compared to EX4 and CEX2. FIG. 5b shows the quantity of H₂S evolved over 15 minutes for EX1-2 versus CEX1, and it is evident that H₂S evolution is considerably lesser for EX2 and EX1 when compared to CEX1.

TABLE 2
H₂S measurement over 15 minutes,
for CEX1-2, EX1-2 and EX4-7.

| | H₂S generated |
|---|---|
| | after 15 minutes |
| Examples | (mmol · L⁻¹ · mol⁻¹) |
| CEX1 | 3.1 |
| EX1 | 2.5 |
| EX2 | 1.8 |
| CEX2 | 2.8 |
| EX4 | 2.7 |
| EX5 | 1.6 |
| EX6 | 1.4 |
| EX7 | 1.4 |

1-17. (canceled)

18. A solid electrolyte having a composition according to formula (I′) 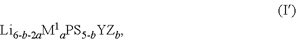
wherein 0<a<0.3,
wherein 0<b<0.8,
wherein M¹ is a divalent metal,
wherein Y is selected from the group consisting of F, Cl, Br, and I,
wherein Z is selected from the group consisting of F, Cl, Br, and I, and
wherein Y and Z are not the same halogen.

19. The solid electrolyte according to claim 18, wherein M¹ is selected from the group consisting of Zn, Cd, Be, Sr, Ba, and combinations thereof.

20. The solid electrolyte according to claim 18, having a composition according to formula (I)

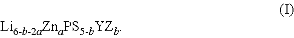

21. The solid electrolyte according to claim 18, wherein 0.01≤a≤0.29.

22. The solid electrolyte according to claim 18, wherein 0<a≤0.2.

23. The solid electrolyte according to claim 18, wherein 0.1≤b<0.8.

24. The solid electrolyte according to claim 23, wherein 0.5≤b≤0.6.

25. The solid electrolyte according to claim 18, wherein Y is F, Br or I.

26. The solid electrolyte according to claim 18, wherein Z is F, Cl or I.

27. The solid electrolyte according to claim 18, having a composition according to formula (II)

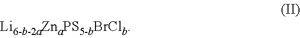

28. The solid electrolyte according to claim 18, having a composition according to formula (II)a-g:

| | |
|---|---|
| Li_{5.35}Zn_{0.025}PS_{4.4}Br_{1.0}Cl_{0.6} | (II)a |
| Li_{5.30}Zn_{0.05}PS_{4.4}Br_{1.0}Cl_{0.6} | (II)b |
| Li_{5.45}Zn_{0.025}PS_{4.5}Br_{1.0}Cl_{0.5} | (II)c |
| Li_{5.40}Zn_{0.05}PS_{4.5}Br_{1.0}Cl_{0.5} | (II)d |
| Li_{5.35}Zn_{0.075}PS_{4.5}Br_{1.0}Cl_{0.5} | (II)e |
| Li_{5.30}Zn_{0.10}PS_{4.5}Br_{1.0}Cl_{0.5} | (II)f |
| Li_{5.20}Zn_{0.15}PS_{4.5}Br_{1.0}Cl_{0.5} | (II)g |

29. The solid electrolyte according to claim 18, having an ionic conductivity between 1 and 12 mS/cm.

30. The solid electrolyte according to claim 18, having a F-43m space group.

31. The solid electrolyte according to claim 18, wherein the solid electrolyte generates less than 2.8 mmol·L⁻¹·mol⁻¹ H₂S after 15 minutes, as determined via moisture stability.

32. A method for manufacturing a solid electrolyte, comprising the following steps:
a) providing a set of precursors comprising Li, P, S, M², Y and Z;
b) mixing the set of precursors to obtain a solid electrolyte mixture; and
c) heat-treating the solid electrolyte mixture to obtain a solid electrolyte;
wherein M² is a divalent metal,
wherein Y is selected from the group consisting of F, Cl, Br, and I,
wherein Z is selected from the group consisting of F, Cl, Br, and I, and
wherein Y and Z are not the same halogen.

33. The method according to claim 32, wherein the set of precursors comprises Li₂S, P₂S₅, ZnS, LiY, and LiZ.

34. A battery comprising a negative electrode, a positive electrode, and a solid electrolyte layer, wherein at least one of the positive electrode, the negative electrode, and the solid electrolyte layer comprises the solid electrolyte according to claim 18.
